(19) United States
(12) Patent Application Publication
(10) Pub. No.: US 2012/0286089 A1
(43) Pub. Date: Nov. 15, 2012

(54) Strain reduction on a balloon system in extreme weather conditions

(75) Inventor: Mark E. Ogram, Tucson, AZ (US)

(73) Assignee: Safe, Inc., Tempe, AZ (US)

(21) Appl. No.: 13/103,988

(22) Filed: May 9, 2011

(51) Int. Cl. B64B 1/50

(52) U.S. Cl. 244/33

(57) ABSTRACT

The subject matter described herein relates to strain reduction on a balloon system in extreme weather conditions. The strain reduction is achieved by using an elastic bungee between a balloon and the tether attached to the balloon. As wind pushes on the balloon, immediate pressure caused by the wind is cushioned on the elastic bungee rather than on the balloon or the tether, thereby reducing immediate force and tension on either the balloon or the tether. Thus, the balloon system that includes the balloon and the tether is protected from damage that can possibly be caused by tension due to pressure.

### TECHNICAL FIELD

The subject matter described herein relates to strain reduction on a balloon system in extreme weather conditions by using an elastic bungee.

### BACKGROUND

FIG. 1 illustrates a conventional balloon system 100 that may include a balloon 102 and a tethering system 103. The tethering system 103 may include one or more branch tethers 104 and a trunk tether 105. The trunk tether 105 may be connected to ground (or base) 106.

When the balloon 102 is aloft, there may be a tremendous pressure upon the balloon 102 and the tethers 104, 105 due to winds in the atmosphere. This tremendous pressure may cause an enormous strain on the balloon 102 and the tethers 104, 105. Further, when the balloon 102 may be withdrawn from or pulled towards a base (or ground) 106, the strain on the balloon 102 and the tethers 104, 105 may increase. This increased strain may decrease the durability of the balloon system 100. Further, this strain may render the balloon system 100 dysfunctional.

Therefore, there is a need for reducing the strain caused on the balloon 102 and the tethers 104, 105 of the balloon system 100.

### SUMMARY

The subject matter described herein relates to strain reduction on a balloon system in extreme weather conditions. The strain reduction is achieved by using an elastic bungee between a balloon and the tether attached to the balloon. As wind pushes on the balloon, immediate pressure caused by the wind is cushioned on the elastic bungee rather than on the balloon or the tether, thereby reducing immediate force and tension on either the balloon or the tether. Thus, the balloon system that includes the balloon and the tether is protected from damage that can possibly be caused by tension due to pressure.

In one aspect, a system includes a balloon, a grounded base, and one or more tethers that tether the balloon to the grounded base. The system further includes at least one elastic bungee connected to the one or more tethers between the balloon and the grounded base to provide an isolated strain reduction to the one or more tethers and the balloon due to pressure exerted on the balloon from atmospheric wind around the balloon.

In another aspect, an electricity collection system includes a balloon having one or more atmospheric electrical energy collectors. The system further includes a grounded base, and one or more conductive tethers that tether the balloon to the grounded base and transfer collected atmospheric electrical energy from the balloon to a storage associated with the grounded base. The system further includes at least one elastic bungee connected to the one or more tethers between the balloon and the grounded base to provide an isolated strain reduction to the one or more tethers and the balloon due to pressure exerted on the balloon from atmospheric wind around the balloon.

The subject matter described herein provides many advantages. For example, the elastic nature of the bungee reduces the strain that can be caused on the balloon and the tether of the balloon system if the elastic bungee is absent. The reduction of the strain prevents the balloon system from being dysfunctional or broken due to increased strain. Further, the reduction of the strain increases life of the balloon system i.e. allows the balloon to be suspended for a longer time while functions required by the balloon are still being performed.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a conventional balloon system that includes a balloon and a tether holding the balloon;

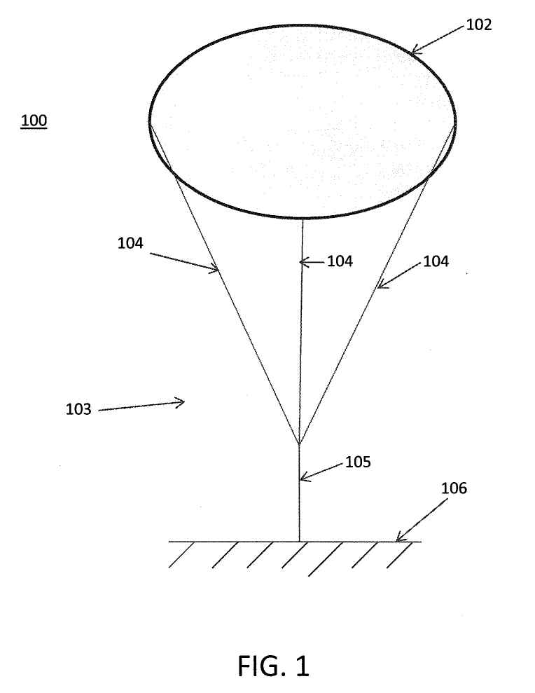

FIG. 2 illustrates some variations of a balloon-system 200 consistent with implementations of the current subject matter; and

FIG. 3 illustrates some variations of a balloon-system 300 consistent with implementations of the current subject matter.

When practical, similar reference numbers denote similar structures, features, or elements.

### DETAILED DESCRIPTION

To address these and potentially other issues with currently available solutions, one or more implementations of the current subject matter provide methods, systems, articles or manufacture, and the like that can, among other possible advantages, provide strain reduction on a balloon system in extreme weather conditions by using an elastic bungee.

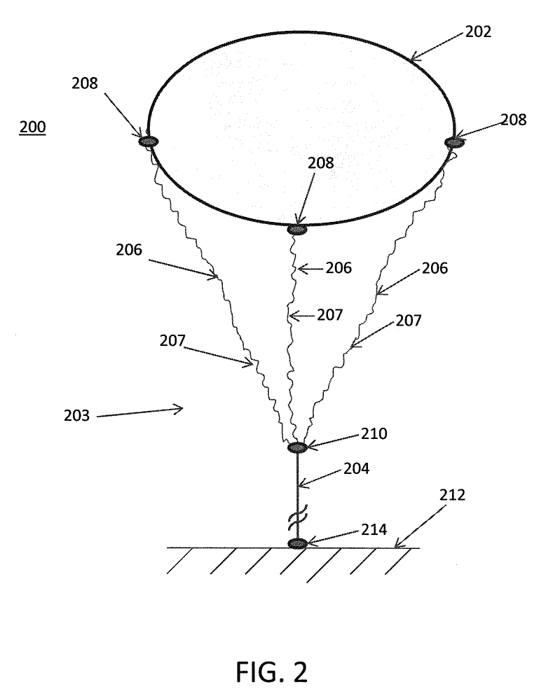

FIG. 2 illustrates some variations of a balloon system 200 consistent with implementations of the current subject matter. The balloon system 200 may include a balloon 202 and a tethering system 203. The tethering system 203 may include a trunk tether 204 and one or more branch tethers 206. The trunk tether 204 may be made of electricity conducting material, such as gold, silver, copper, aluminum, and the like. In one implementation, the trunk tether 204 may be made of any material coated with an electrical conducting material, such as gold, silver, copper, aluminum, and the like. The one or more branch tethers 206 connect the balloon 202 to the trunk tether 204. At least one of the one or more branch tethers 206 may include an elastic bungee 207. Although FIG. 2 illustrates that the branch tether 206 entirely consists of the elastic bungee 207, one of ordinary skill in the art may comprehend that elastic bungee 207 may be just an upper portion of the length of the corresponding branch tether 206. The portion of the one or more branch tethers 206, which may not be an elastic bungee 207, may be made of an electrical conductor, such as gold, silver, copper, aluminum, and the like. In one implementation, the portion of the one or more branch tethers 206, which is not an elastic bungee 207, may be made of any material, that is coated with an electrical conducting material, such as gold, silver, copper, aluminum, and the like.

The balloon 202 may be connected with the elastic bungee 207 by a first attachment mechanism 208. In one implementation, the first attachment mechanism 208 may be a threading mechanism. In other implementations, other attachments mechanisms may be used, such as a soldering mechanism, a nut and bolt mechanism, a glue mechanism, and the like. The elastic bungee 207 may be connected to the trunk tether 204 by using a second attachment mechanism 210. In one implementation, the second attachment mechanism 210 may be a threading mechanism. In other implementations, other attachments mechanisms may be used, such as a soldering mechanism, a nut and bolt mechanism, a glue mechanism, and the like. The trunk tether 204 may be connected to the base 212 using a third attachment mechanism 214. The base 212 may be made of an electricity collection mechanism or an electricity collecting storage. In one implementation, the third attachment mechanism 214 may be a threading mechanism. In other implementations, other third attachments mechanisms 214 may be used, such as soldering mechanism, nut and bolt mechanism, glue mechanism, and the like.

In one implementation, the third attachment mechanism 214 may include a winch and spool apparatus that may be used to withdraw or release the trunk tether 204 so that the withdrawal or the releasing adjusts the location (height from base 212) of the balloon 202. The location (height) of the balloon 202 may be adjusted such that the balloon 202 may be at an optimum position for an appropriate amount of wind to hit the balloon 202 at desired places on the balloon 202. In one implementation, the winch and spool apparatus may withdraw or release the trunk tether 204 such that the balloon 202, which may include atmospheric electrical energy collectors, may be at an appropriate location (height and orientation) to collect maximum atmospheric electrical energy. Although a winch and spool apparatus is discussed above, one of ordinary skill in the art understands that other third attachment mechanisms 214 may be used, such as a pulley, a wheel, and the like. In one implementation, the withdrawal and the release of the tether 204 may be performed manually.

Further, although three straps of elastic bungee 207 have been illustrated in FIG. 2, one of ordinary skill in the art understands that any number of straps may be implemented.

As wind pushes on the balloon 202, immediate tension on the balloon 202 or the tether 204 caused by the wind may be cushioned or absorbed by the elastic bungee 207, thereby reducing immediate force and tension on either the balloon 202 or the trunk tether 204. Thus, the balloon system 200 that includes the balloon 202 and the trunk tether 204 may be protected from damage that can possibly be caused by tension due to pressure.

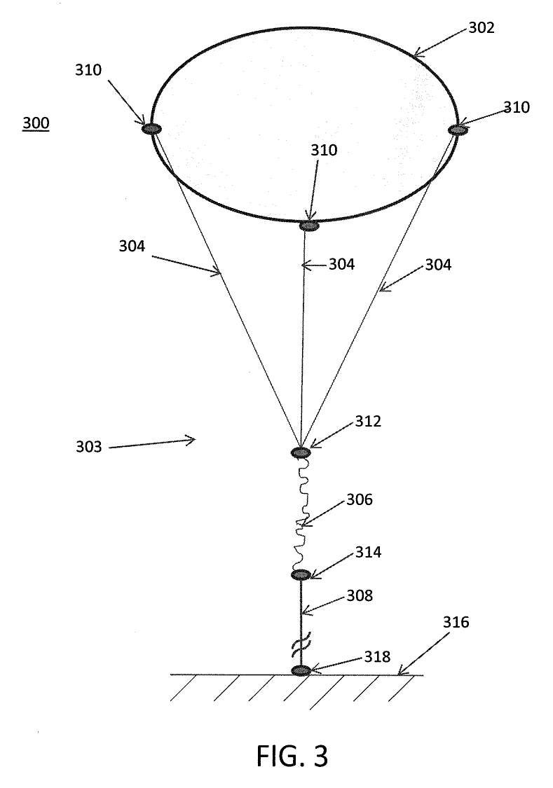

FIG. 3 illustrates some variations of a balloon system 300 consistent with implementations of the current subject matter. The balloon system 300 includes a balloon 302 and a tethering system 303. The tethering system 303 may include one or more branch tethers 304, an elastic bungee 306, and a trunk tether 308. The trunk tether 308 may be made of an electrical conducting material, such as gold, silver, copper, aluminum, and the like. In another implementation, the trunk tether 308 may be made of any material that is coated with an electrical conducting material, such as gold, silver, copper, aluminum, and the like. In one implementation, some portion of the elastic bungee 306 may be coated with an electrical conducting material, such as gold, silver, copper, aluminum, and the like.

The balloon 302 may be connected with the one or more branch tethers 304 by using corresponding one or more first attachment mechanisms 310. In one implementation, a first attachment mechanism 310 may be a threading mechanism. In other implementations, other first attachments mechanisms 310 may be used, such as soldering mechanism, nut and bolt mechanism, glue mechanism, and the like. The branch tethers 304 may be connected to the elastic bungee 306 by using a second attachment mechanism 312. In one implementation, the second attachment mechanism 312 may be a threading mechanism. In other implementations, other second attachments mechanisms 312 may be used, such as soldering mechanism, nut and bolt mechanism, glue mechanism, and the like. The elastic bungee 306 may be connected to the trunk tether 308 by using a third attachment mechanism 314. In one implementation, the third attachment mechanism 314 may be a threading mechanism. In other implementations, other third attachments mechanisms 314 may be used, such as soldering mechanism, nut and bolt mechanism, glue mechanism, and the like. The trunk tether 308 may be connected to the ground/base 316 by using a fourth attachment mechanism 318. In one implementation, the fourth attachment mechanism 318 may be a threading mechanism. The base 316 may be made of an electricity collection mechanism or an electricity collecting storage. In other implementations, other fourth attachments mechanisms 318 may be used, such as soldering mechanism, nut and bolt mechanism, glue mechanism, and the like.

In one implementation, the fourth attachment mechanism 318 may include a winch and spool apparatus that may be used to withdraw or release the trunk tether 308 so that the withdrawal or the releasing adjusts the location (height from base 316) of the balloon 302. The location (height) of the balloon 302 may be adjusted such that the balloon 302 may be at an optimum position for an appropriate amount of wind to hit the balloon 302 at desired places on the balloon 302. In one implementation, the winch and spool apparatus may withdraw or release the trunk tether 308 such that the balloon 302, which may include atmospheric electrical energy collectors, may be at an appropriate location to collect maximum atmospheric electrical energy. Although a winch and spool apparatus is discussed above, one of ordinary skill in the art understands that other fourth attachment mechanisms 318 may be used, such as a pulley, a wheel, and the like. In one implementation, the withdrawal and the release of the trunk tether 308 may be performed manually.

Further, although three straps (branch tethers) 304 have been illustrated in FIG. 3, one of ordinary skill in the art understands that any number of straps may be implemented.

As wind pushes on the balloon 302, immediate pressure caused by the wind may be cushioned on the elastic bungee 306 rather than on the balloon 302, the tethers 304 or the tether 308, thereby reducing immediate force and tension on either the balloon 302 or the tethers 304, 308. Thus, the balloon system 300, which may include the balloon 302 and the tethers 304, 308, may be protected from damage that can possibly be caused by tension due to pressure.

Although two implementations of the current subject matter have been described above with respect to FIGS. 2 and 3, it may be noted that other like implementations are possible. For example, a particular strap in the balloon-system may include any possible combination of an elastic bungee part and a tether, which may be non-elastic or relatively less elastic than the elastic bungee part.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A system comprising:
a balloon;
a grounded base;
one or more tethers that tether the balloon to the grounded base; and
at least one elastic bungee connected to the one or more tethers between the balloon and the grounded base to provide an isolated strain reduction to the one or more tethers and the balloon due to pressure exerted on the balloon from atmospheric wind around the balloon.

2. The system in accordance with claim 1, further comprising one or more attachment mechanisms that attach the at least one elastic bungee to each of the one or more tethers.

3. The system in accordance with claim 1, wherein the at least one elastic bungee has a coefficient of elasticity sufficient to react at tensions greater than 500 pounds.

4. The system in accordance with claim 1, wherein the at least one elastic bungee consists of one elastic bungee.

5. The system in accordance with claim 1, wherein the at least one elastic bungee includes two or more elastic bungees.

6. A strain reduction system for a balloon, the system comprising:
a grounded base;
one or more tethers that tether the balloon to the grounded base; and
at least one elastic bungee connected to the one or more tethers between the balloon and the grounded base to provide an isolated strain reduction to the one or more tethers and the balloon due to pressure exerted on the balloon from atmospheric wind around the balloon.

7. The system in accordance with claim 6, further comprising one or more attachment mechanisms that attach the at least one elastic bungee to each of the one or more tethers.

8. The system in accordance with claim 6, wherein the at least one elastic bungee has a coefficient of elasticity sufficient to react at tensions greater than 500 pounds.

9. The system in accordance with claim 6, wherein the at least one elastic bungee consists of one elastic bungee.

10. The system in accordance with claim 6, wherein the at least one elastic bungee includes two or more elastic bungees.

11. An electricity collection system comprising:
a balloon having one or more atmospheric electrical energy collectors;
a grounded base;
one or more conductive tethers that tether the balloon to the grounded base and transfer collected atmospheric electrical energy from the balloon to a storage associated with the grounded base; and
at least one elastic bungee connected to the one or more tethers between the balloon and the grounded base to provide an isolated strain reduction to the one or more tethers and the balloon due to pressure exerted on the balloon from atmospheric wind around the balloon.

12. The system in accordance with claim 11, further comprising one or more attachment mechanisms that attach the at least one elastic bungee to each of the one or more tethers.

13. The system in accordance with claim 11, wherein the at least one elastic bungee has a coefficient of elasticity sufficient to react at tensions greater than 500 pounds.

14. The system in accordance with claim 11, wherein the at least one elastic bungee consists of one elastic bungee.

15. The system in accordance with claim 11, wherein the at least one elastic bungee includes two or more elastic bungees.
